(19) United States
(12) Patent Application Publication
(10) Pub. No.: US 2011/0309923 A1
(43) Pub. Date: Dec. 22, 2011

(54) Thermal Detection Device for a Reversing Vehicle

(76) Inventors: Matthew James Kennerly, Albany, OR (US); Brian Daniel Kennerly, Albany, OR (US); Gary Lee Jones, Onekawa (NZ)

(21) Appl. No.: 13/166,532

(22) Filed: Jun. 22, 2011

Related U.S. Application Data
(60) Provisional application No. 61/357,149, filed on Jun. 22, 2010.

(51) Int. Cl. B60Q 1/00

(52) U.S. Cl. 340/436

(57) ABSTRACT

The present invention is a thermal detection device for a reversing vehicle. The thermal detection device for a reversing vehicle warns driver of any warm bodied obstruction such as a person or an animal. The present invention utilizes digital pryoelectric sensors as means to detect a warm bodied obstruction. The digital pryoelectric sensors are compact and accurate and are sensitive to a warm bodied object at a relatively far distance. The present invention geometrically positions the digital pryoelectric sensors so that the present invention can detect a warm bodied obstruction with almost a 180° field of vision behind the vehicle. The present invention notifies the driver of a warm bodied obstruction entering the vehicle's reverse path with both a visual and an aural warning.

The current application claims a priority to the U.S. Provisional Patent application Ser. No. 61/357,149 filed on Jun. 22, 2010.

### FIELD OF THE INVENTION

The present invention generally relates to safety detector device for a vehicle moving in reverse. The objective of the present invention is to accurately detect animals or people obstructing the path of the vehicle moving in reverse, to warn the driver, and to prevent a collision with the animal or person.

### BACKGROUND OF THE INVENTION

Many accidents occur because of the driver's limited rear view vision while backing up a vehicle. Traditional sensors used to determine if a vehicle is in danger of a collision have a very limited detection range and does not provide the driver with an optimum field of vision behind the vehicle. The present invention allows the driver to have almost a full 180° field of vision behind the vehicle and notifies the driver of a warm body, such as an animal or a person, obstructing the vehicle's reverse path. The present invention for the safety of all pedestrians, pets, and drivers. The present invention would make all vehicles with a low reverse visibility, such as semi trucks or school buses, instantly safer.

### BRIEF DESCRIPTION OF THE DRAWINGS

FIG. 1 is an electrical diagram of the present invention with a simplified electrical diagram of the detection devices.

FIG. 2 is a top cross-sectional view of the detection devices and the detection enclosure highlighting each detection device's field of vision with the dashed lines.

FIG. 3 is a back view of the detection device and the detection enclosure.

FIG. 4 is a top view of the mounting bracket.

FIG. 5 is back view of the mounting bracket.

FIG. 6 is side view of the mounting bracket.

### DETAIL DESCRIPTIONS OF THE INVENTION

All illustrations of the drawings are for the purpose of describing selected versions of the present invention and are not intended to limit the scope of the present invention.

The present invention is a thermal detection device for a reversing vehicle, which notifies an user of a warm body in the path of a vehicle moving backwards. The present invention is only able to detect the infrared motion of warm bodies such as humans, dogs, cats, and other animals. The present invention comprises a first detection device 1, a second detection device 10, a detector enclosure 11, an alert system 17, an accessory splice connector 20, a reverse light splice connector 21, a ground 22, a relay 23, a mounting bracket 27, and a plurality of wires 26. The first detection device 1 and the second detection device 10 allow the present invention to sense the infrared motion of a warm body. The first detection device 1 and the second detection device 10 are housed within the detector enclosure 11 in order to protect the first detection device 1 and the second detection device 10 and to position the first detection device 1 and the second detection device 10 in the appropriate geometric arrangement. The mounting bracket 27 allows the user to properly secure the detector enclosure 11 to the back of the vehicle and to adjust the positioning of the detector enclosure 11. The alert system 17 is electrically connected to the first detection device 1 and the second detection device 10 and notifies the user of a warm body obstructing the reserve path of the vehicle with a combination of light and sound. The relay 23 allows the alert system 17 to activate only when the vehicle is moving backwards and the vehicle's reverse lights are turned on. The relay 23 is electrically connected in between the reverse light circuit with the reverse light splice connector 21 and the ground 22. A potential difference between the accessory splice connector 20 and the ground 22 powers the first detection device 1, the second detection device 10, and the alert system 17.

The first detection device 1 and the second detection device 10 are compact, reliable sensors used to detect infrared motion. The first detection device 1 and the second detection device 10 each comprise three main components: the digital pryoelectric sensor 2, the processor 3, and the circuit board 4. The digital pryoelectric sensor 2 senses the infrared motion with a piece of pryoelectric material, which produces a temporary voltage when heated or cooled. The field of vision for each detection device emanates from the digital pryoelectric sensor 2 with an arc of 45°. After the digital pryoelectric material detects the infrared motion of a warm body, the digital pryoelectric sensor 2 produces and sends a digital signal describing the amplitude of the infrared electromagnetic waves to the processor 3. The digital pryoelectric sensor 2 sends the digital signal to the processor along the circuit board 4, to which both the digital pryoelectric sensor 2 and the processor 3 are electronically connected. The circuit board 4 has a number of connection ports important to the present invention, which includes a positive voltage supply 5, a negative voltage supply 6, a sensitivity terminal 7, a dwell terminal 8, and an output 9. The positive voltage supply 5 and the negative voltage supply 6 power the digital pryoelectric sensor 2 and the processor 3. The sensitivity terminal 7 allows the user to adjust the detection range of the digital pryoelectric sensor 2. The processor 3 turns on the output 9 when the digital pryoelectric sensor 2 detects the infrared motion of a warm body. The dwell terminal 8 allows the user to adjust how long the output 9 will stay on after the digital pryoelectric sensor 2 detects the infrared motion of a warm body. Both the dwell terminal 8 and the sensitivity terminal 7 will be preset by the manufacturer to be one second for the dwell time and 15 feet sensitivity radius.

The alert system 17 visually and audibly warns the user once the first detection device 1 or the second detection device 10 senses a warm body obstructing the reverse path of the vehicle. The alert system 17 consists of an illumination device 19 and a buzzer 18. The illumination device 19 emits light once the output 9 of either the first detection device 1 or the second detection device 10 is turned on. In the preferred embodiment of the present invention, the illumination device 19 is a light emitting diode electrically connected in series with a resistor. The light emitting diode is ideal for the present invention because a light emitting diode consumes relatively less power than other options that emit light. The buzzer 18 is a device that produces a sound once the output 9 of either the first detection device 1 or the second detection device 10 is turned on. In the preferred embodiment of the present invention, the buzzer 18 contains a piezoelectric element, which will vibrate to produce sound once a voltage is applied to the buzzer 18. Also in the preferred embodiment, the buzzer 18 can have an adjustable volume control with a maximum volume of 100 dB to 120 dB. The alert system 17 is located in cabin of the vehicle so that the driver can easily hear and see the alert system 17 once the alert system 17 has been activated. The illumination device 19 is preferably mounted in direct view of the driver such as on the dashboard or the windshield. The buzzer 18 is preferably mounted under the dashboard because the buzzer 18 will still function and will not ruin the aesthetic appearance of the vehicle's cabin, but the buzzer 18 can also be mounted on the dashboard.

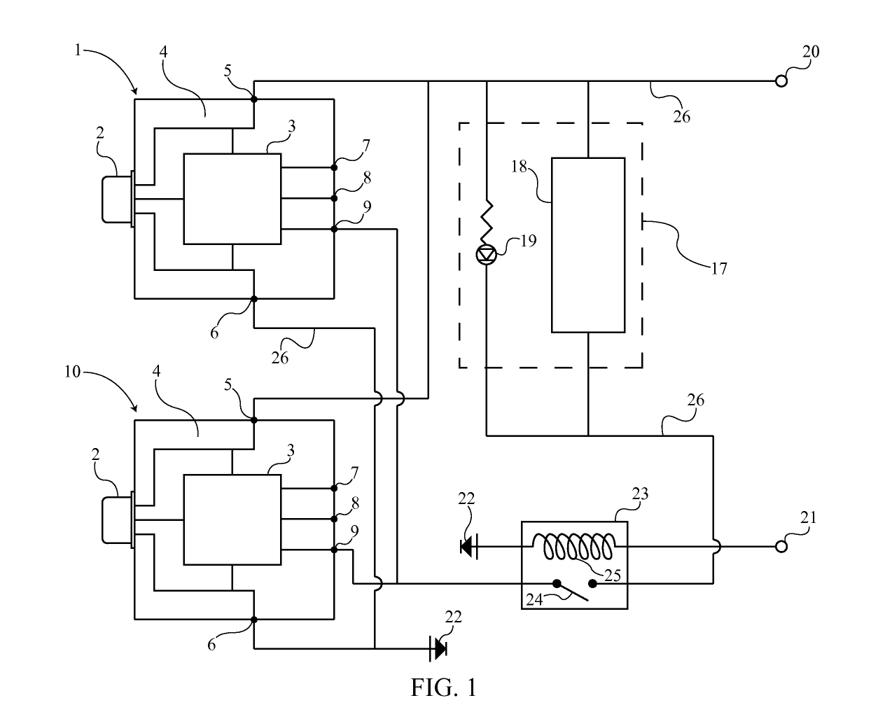

The plurality of wires 26 is used to electrically connect the first detection device 1, the second detection device 10, and the alert system 17 into an electrical circuit, which is illustrated in FIG. 1. All electrical connections within the electrical circuit of the present invention are made with the plurality of wires 26. In the preferred embodiment of the present invention, the plurality of wires 26 are insulated copper wire with a wire gauge of 22. First, the accessory splice connector 20 attaches to a wire sending power from the vehicle's 12 volt battery to the vehicle's accessories. The accessory splice connector 20 is electrically connected to the positive voltage supply 5 of the first detection device 1, the positive voltage supply 5 of the second detection device 10, the illumination device 19, and the buzzer 18. The relay 23 consists of a switch 24 and a coil 25 and is mounted on the inside of the vehicle in a dry place. In the preferred embodiment of the present invention, the relay 23 is single pole single throw. The output 9 of the first detection device 1 and the output 9 of the second detection device 10 is electrically connected the switch 24. The switch 24 is also electrically connected to the illumination device 19 and the buzzer 18, which means the outputs 9 can be electrically connected to the alert system 17. The relay 23 keeps the switch 24 in the opened position, which breaks the electrical connection between the outputs 9 and the alert system 17, until the coil 25 is activated and moves the switch 24 into the closed position. The coil 25 is electrically connected in between the reverse light splice connector 21 and the ground 22. The reverse light splice connector 21 attaches to a wire sending power from the vehicle's 12 volt battery to the vehicle's reverse light, and the ground 22 is common return path for current flowing through the electrical circuit of the present invention. Thus, if the vehicle's reverse lights are turned on, the electrical current flowing in between the reverse light splice connector 21 and the ground 22 will activate the coil 25. Activating the coil 25 will move the switch 24 to the closed position and electrically connect the outputs 9 to the alert system 17. Once the outputs 9 are electrically connected to the alert system 17, the illumination device 19 and the buzzer 18 will turn on if a warm body enters the field of vision either the first detection device 1 or the second detection device 10. Finally, the negative voltage supply 6 of the first detection device 1 and the negative voltage supply 6 of the second detection device 10 is also electrically connected to the ground 22. The first detection device 1 and the second detection device 10 are electrically connected in parallel with each other in between the accessory splice connector 20 and the ground 22 so that both the first detection device 1 and the second detection device 10 are powered by the electrically current flowing from the accessory splice connector 20 to the ground 22. The present invention can easily be installed by a stereo technician, a mechanic shop, or anywhere that has a certified auto technician. The present invention can be installed on any vehicle operating with an electrical system of 5 volts to 15 volts.

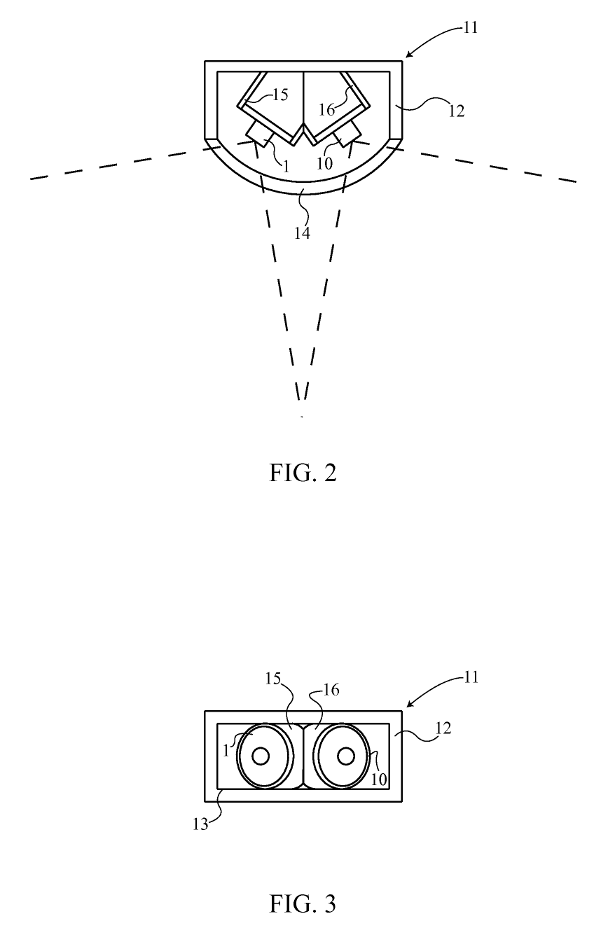

As can be seen in FIGS. 2 and 3, the detector enclosure 11 provides the present invention with a place to support, align, and protect the first detection device 1 and the second detection device 10. The detector enclosure 11 comprises a casing 12, a window hole 13, a transparent lens 14, a first tube 15, and a second tube 16. The casing 12 is a rigid open container used to protect the first detection device 1 and the second detection device 10 from getting damaged. The window hole 13 is positioned on the back of the casing 12, which allows the field of vision for the first detection device 1 and the field of vision for the second detection device 10 to originate from inside of the casing 12, go through the window hole 13, and emanate into the area behind the vehicle. The window hole 13 is covered with the transparent lens 14 as a further means of protection for the first detection device 1 and the second detection device 10 without comprising the field of vision for either the first detection device 1 or the second detection device 10. The transparent lens 14 is made of a material that allows infrared electromagnetic waves to easily traverse through the transparent lens 14. In the preferred embodiment of the present invention, the transparent lens 14 is made of polyethylene, which least distorts the path of the infrared electromagnetic waves. The detector enclosure 11 might also use baffles (vertically mounted strips of a solid material approximately 1/16″ in width, mounted 1/16″ in front of the front face, and directly in front of the window hole 13). The first tube 15 and the second tube 16 are connected to and positioned inside of the casing 12 on the side opposite to the window hole 13. The perimeter of the first detection device 1 is connected to the first tube 15 opposite to the casing 12, and the perimeter of the second detection device 10 is similarly connected to the second tube 16 opposite to the casing 12. The digital pryoelectric sensor 2 of the first detection device 1 and the digital pryoelectric sensor 2 of the second detection device 10 are both facing the transparent lens 14 from inside of the casing 12. The center axis of the detector enclosure 11 traverses through the center of the front of the casing 12 and through the center of the transparent lens 14. The first tube 15 positions the first detection device 1 in such a way that the center axis of the first detection device 1 is angled 35° away from the center axis of the detector enclosure 11. Likewise, the second tube 16 positions the second detection device 10 in such a way that the center axis of the second detection device 10 is angled 35° away from the center axis of the detector enclosure 11. Thus, the center axis of the first detection device 1 and the center axis of the second detection device 10 are angled 70° away from each other. The positioning of the first detection device 1 and the second detection device 10 provides the present invention with a combined field of vision of 170° behind the vehicle. The combined field of vision 170° allows the present invention to detect a warm body approaching the back of the vehicle from either the rear or the sides.

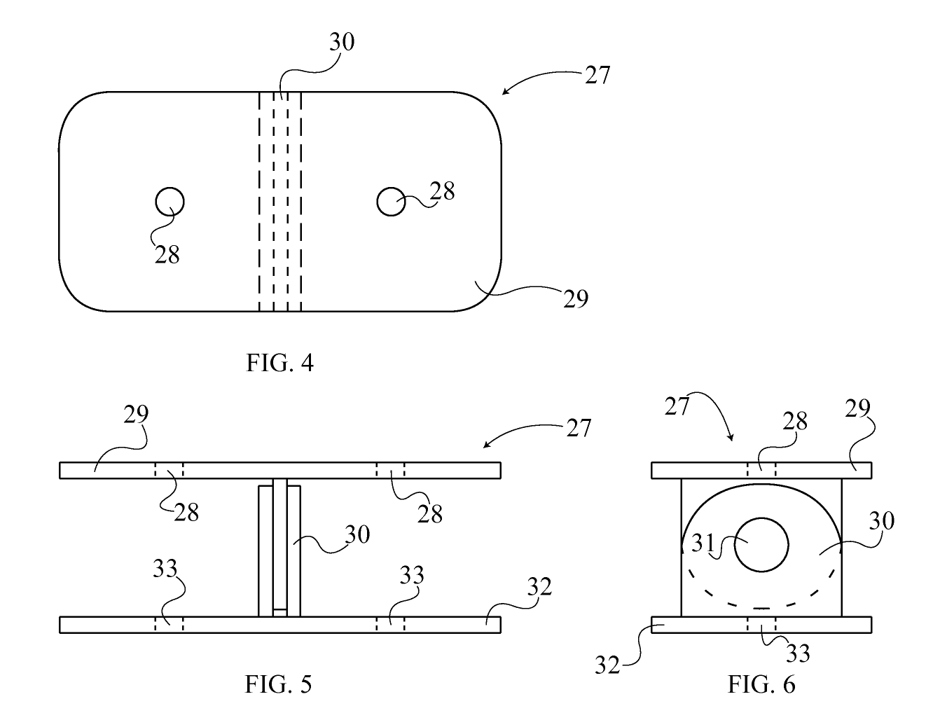

The mounting bracket 27 attaches the detector enclosure 11 to the vehicle and is shown in FIGS. 4, 5, and 6. The mounting bracket 27 also allows the user to adjust the vertical positioning of the detector enclosure 11. The mounting bracket 27 comprises a pair of vehicle fasteners 28, a vehicle brace 29, a vertical swivel 30, a swivel fastener 31, an enclosure brace 32, and a pair of enclosure fasteners 33. The enclosure brace 32 is a plate that attaches to the top of the casing 12 with the pair of enclosure fasteners 33. The vertical swivel 30 jointly connects the enclosure brace 32 to the vehicle brace 29. The vertical swivel 30 allows the user to change the vertical positioning between the enclosure brace 32 and the vehicle brace 29. If the mounting bracket 27 had the ability to change the horizontal positioning between the enclosure brace 32 and the vehicle brace 29, then the first detection device 1 and the second detection device 10 might be misalign and the present invention will not be able to take full advantage of its the combined field of vision of 170°. The swivel fastener 31 is used to tighten the vertical swivel 30 when the vertical positioning between the enclosure brace 32 and the vehicle brace 29 is deemed acceptable by the user. In the preferred embodiment of the present invention, the swivel fastener 31 is a wing nut. The vehicle brace 29 is a plate that attaches to the back of vehicle with the pair of vehicle fasteners 28. Also in the preferred embodiment of the present invention, the vehicle brace 29 is attached to the bottom of the vehicle's bumper at the center.

Although the invention has been explained in relation to its preferred embodiment, it is to be understood that many other possible modifications and variations can be made without departing from the spirit and scope of the invention as hereinafter claimed.

What is claimed is:

1. A thermal detection device for a reversing vehicle comprises,
a first detection device;
a second detection device;
a detector enclosure;
an alert system;
an accessory splice connector;
a reverse light splice connector;
a ground;
a relay
a plurality of wires;
a mounting bracket;
said first detection device and said second detection device each comprise a digital pryoelectric sensor, a processor, and a circuit board;
said detector enclosure comprises a casing, a window hole, a transparent lens, a first tube, and a second tube;
said alert system comprises a buzzer and an illumination device;
said mounting bracket comprises a pair of vehicle fasteners, a vehicle brace, a vertical swivel, a swivel fastener, an enclosure brace, and a pair of enclosure fasteners; and
said circuit board comprises a positive voltage supply, a negative voltage supply, a sensitivity terminal, a dwell terminal, and an output.

2. The thermal detection device for a reversing vehicle as claimed in claim 1 comprises,
said first detection device and said second detection device being attached and located within said detector enclosure;
said first detection device and said second detection device being symmetrically positioned with said detector enclosure;
said mounting bracket being attached to said detector enclosure;
said accessory splice connector, said first detection device, said second detection device, and said alert system being electrically connected to each other with said plurality of wires;
said relay being electrically connected to said first detection device, said second detection device, said alert system, said reverse light splice connector, and said ground by said plurality of wires; and
said first detection device and said second detection device being electrically connected to said ground by said plurality of wires.

3. The thermal detection device for a reversing vehicle as claimed in claim 1 comprises,
said digital pryoelectric sensor being electronically connected to said processor with said circuit board.

4. The thermal detection device for a reversing vehicle as claimed in claim 1 comprises,
said positive voltage supply of said first detection device, said positive voltage supply of said second detection device, said illumination device, and said buzzer being electrically connected to said accessory splice connector by said plurality of wires;
said output of said first detection device and said output of said second detection device being electrically connected to said switch by said plurality of wires;
said illumination device and said buzzer being electrically connected to said switch opposite said output of said first detection device and said output of said second detection device by said plurality of wires;
said switch being positioned within said relay;
said coil being positioned adjacent to said switch within said relay;
said coil being electrically connected in between said reverse light splice connector and said ground by said plurality of wires; and
said negative voltage supply of said first detection device and said negative voltage supply of said second detection device being electrically connected to said ground by said plurality of wires.

5. The thermal detection device for a reversing vehicle as claimed in claim 1 comprises,
said window hole being located behind and positioned on said casing;
said window hole being covered by said transparent lens;
said transparent lens being perimetrically connected to said casing;
said first tube and said second tube being located adjacent to each other and within said casing;
said first tube and said second tube being centrally connected to said casing opposite said window hole;
said first detection device being perimetrically connected to said first tube opposite said casing;
said second detection device being perimetrically connected to said second tube opposite said casing;
said first detection device and said second detection device being angled 70 degrees away from each other by said first tube and said second tube; and
said first detection device and said second detection device symmetrically facing said transparent lens.

6. The thermal detection device for a reversing vehicle as claimed in claim 1 comprises,
said enclosure brace being attached atop said casing with said pair of enclosure fasteners;
said enclosure brace being jointly attached to said vehicle brace with said vertical swivel;
said vertical swivel being held in place by said swivel fastener; and
said pair of vehicle fastener being positioned on said vehicle brace.

7. A thermal detection device for a reversing vehicle comprises,
a first detection device;
a second detection device;
a detector enclosure;
an alert system;
an accessory splice connector;
a reverse light splice connector;
a ground;
a relay
a plurality of wires;
a mounting bracket;
said first detection device and said second detection device each comprise a digital pryoelectric sensor, a processor, and a circuit board;
said detector enclosure comprises a casing, a window hole, a transparent lens, a first tube, and a second tube;
said alert system comprises a buzzer and an illumination device;
said mounting bracket comprises a pair of vehicle fasteners, a vehicle brace, a vertical swivel, a swivel fastener, an enclosure brace, and a pair of enclosure fasteners;
said circuit board comprises a positive voltage supply, a negative voltage supply, a sensitivity terminal, a dwell terminal, and an output;
said first detection device and said second detection device being attached and located within said detector enclosure;
said first detection device and said second detection device being symmetrically positioned with said detector enclosure;
said mounting bracket being attached to said detector enclosure;
said accessory splice connector, said first detection device, said second detection device, and said alert system being electrically connected to each other with said plurality of wires;
said relay being electrically connected to said first detection device, said second detection device, said alert system, said reverse light splice connector, and said ground by said plurality of wires;
said first detection device and said second detection device being electrically connected to said ground by said plurality of wires;
said window hole being located behind and positioned on said casing;
said window hole being covered by said transparent lens;
said transparent lens being perimetrically connected to said casing;
said first tube and said second tube being located adjacent to each other and within said casing;
said first tube and said second tube being centrally connected to said casing opposite said window hole;
said first detection device being perimetrically connected to said first tube opposite said casing;
said second detection device being perimetrically connected to said second tube opposite said casing;
said first detection device and said second detection device being angled 70 degrees away from each other by said first tube and said second tube; and
said first detection device and said second detection device symmetrically facing said transparent lens.

8. The thermal detection device for a reversing vehicle as claimed in claim 7 comprises,
said digital pryoelectric sensor being electronically connected to said processor with said circuit board;
said positive voltage supply of said first detection device, said positive voltage supply of said second detection device, said illumination device, and said buzzer being electrically connected to said accessory splice connector by said plurality of wires;
said output of said first detection device and said output of said second detection device being electrically connected to said switch by said plurality of wires;
said illumination device and said buzzer being electrically connected to said switch opposite said output of said first detection device and said output of said second detection device by said plurality of wires;
said switch being positioned within said relay;
said coil being positioned adjacent to said switch within said relay;
said coil being electrically connected in between said reverse light splice connector and said ground by said plurality of wires; and
said negative voltage supply of said first detection device and said negative voltage supply of said second detection device being electrically connected to said ground by said plurality of wires.

9. The thermal detection device for a reversing vehicle as claimed in claim 7 comprises,
said enclosure brace being attached atop said casing with said pair of enclosure fasteners;
said enclosure brace being jointly attached to said vehicle brace with said vertical swivel;
said vertical swivel being held in place by said swivel fastener; and
said pair of vehicle fastener being positioned on said vehicle brace.

10. A thermal detection device for a reversing vehicle comprises,
a first detection device;
a second detection device;
a detector enclosure;
an alert system;
an accessory splice connector;
a reverse light splice connector;
a ground;
a relay
a plurality of wires;
a mounting bracket;
said first detection device and said second detection device each comprise a digital pryoelectric sensor, a processor, and a circuit board;
said detector enclosure comprises a casing, a window hole, a transparent lens, a first tube, and a second tube;
said alert system comprises a buzzer and an illumination device;
said mounting bracket comprises a pair of vehicle fasteners, a vehicle brace, a vertical swivel, a swivel fastener, an enclosure brace, and a pair of enclosure fasteners;
said circuit board comprises a positive voltage supply, a negative voltage supply, a sensitivity terminal, a dwell terminal, and an output;
said first detection device and said second detection device being attached and located within said detector enclosure;
said first detection device and said second detection device being symmetrically positioned with said detector enclosure;
said mounting bracket being attached to said detector enclosure;
said accessory splice connector, said first detection device, said second detection device, and said alert system being electrically connected to each other with said plurality of wires;
said relay being electrically connected to said first detection device, said second detection device, said alert system, said reverse light splice connector, and said ground by said plurality of wires;
said first detection device and said second detection device being electrically connected to said ground by said plurality of wires;
said positive voltage supply of said first detection device, said positive voltage supply of said second detection device, said illumination device, and said buzzer being electrically connected to said accessory splice connector by said plurality of wires;
said output of said first detection device and said output of said second detection device being electrically connected to said switch by said plurality of wires;
said illumination device and said buzzer being electrically connected to said switch opposite said output of said first detection device and said output of said second detection device by said plurality of wires;
said switch being positioned within said relay;
said coil being positioned adjacent to said switch within said relay;
said coil being electrically connected in between said reverse light splice connector and said ground by said plurality of wires; and
said negative voltage supply of said first detection device and said negative voltage supply of said second detection device being electrically connected to said ground by said plurality of wires.

11. The thermal detection device for a reversing vehicle as claimed in claim 10 comprises,
said digital pryoelectric sensor being electronically connected to said processor with said circuit board.

12. The thermal detection device for a reversing vehicle as claimed in claim 10 comprises,
said window hole being located behind and positioned on said casing;
said window hole being covered by said transparent lens;
said transparent lens being perimetrically connected to said casing;
said first tube and said second tube being located adjacent to each other and within said casing;
said first tube and said second tube being centrally connected to said casing opposite said window hole;
said first detection device being perimetrically connected to said first tube opposite said casing;
said second detection device being perimetrically connected to said second tube opposite said casing; and
said first detection device and said second detection device symmetrically facing said transparent lens.

13. The thermal detection device for a reversing vehicle as claimed in claim 12 comprises,
said first detection device and said second detection device being angled 70 degrees away from each other by said first tube and said second tube.

14. The thermal detection device for a reversing vehicle as claimed in claim 10 comprises,
said enclosure brace being attached atop said casing with said pair of enclosure fasteners;
said enclosure brace being jointly attached to said vehicle brace with said vertical swivel;
said vertical swivel being held in place by said swivel fastener; and
said pair of vehicle fastener being positioned on said vehicle brace.
